(19) United States
(12) Patent Application Publication
(10) Pub. No.: US 2010/0314561 A1
(43) Pub. Date: Dec. 16, 2010

(54) Device for hardening plastics material liners

(76) Inventor: Thomas Reutemann, Kempten (DE)

Correspondence Address: COLLARD & ROE, P.C., 1077 NORTHERN BOULEVARD, ROSLYN, NY, 11576, US

(21) Appl. No.: 12/800,517

(22) Filed: May 17, 2010

(30) Foreign Application Priority Data
May 18, 2009 (DE) 10 2009 025 829.9

(51) Int. Cl. H01J 29/02

(52) U.S. Cl. 250/522.1

(57) ABSTRACT

Device (1) for hardening plastics material liners for pipe and conduit refurbishment, with at least one ultraviolet light sources (3), wherein rollers (5) for mounting the device (1) in the pipe are provided and wherein a pushing and/or pulling device is provided by which the device (1) can be pushed or pulled through the conduit pipe to be refurbished, wherein several mounts (7) capable of mounting different rollers (5) are provided.

The invention relates to a device for hardening plastics material liners for pipe and conduit refurbishment, with at least one ultraviolet light source, wherein rollers for mounting the device in the pipe are provided and wherein a pushing and/or pulling device is provided by which the device can be pushed or pulled through the conduit pipe to be refurbished.

Various devices of that kind are known.

However, the problem exists with all these devices that they are always only usable for one pipe diameter or one pipe shape.

A multiplicity of different devices is therefore necessary in order to be able to work with the pipe diameters which arise in practice and which are usually between 80 and 1000 millimetres. Added to this are so-called egg profiles having a greater height than width.

The object of the invention is therefore to propose a device which is universally usable with a plurality of different pipe diameters and also with different pipe shapes.

According to the invention this object is fulfilled in that a plurality of mounts capable of mounting different rollers is provided.

The device can thereby be adapted to different pipe diameters and pipe shapes by use of different roller sets.

In this case it has also proved advantageous if the rollers are arranged at arms insertable into the mounts.

A very high level of flexibility of the possibilities of use with, nevertheless, a high degree of stability of the mounting of the rollers is thereby achieved.

An embodiment which is similarly very advantageous in accordance with the invention is also present when the arms are constructed to be adjustable in their length.

The arms can thereby be adapted to different pipe diameters and pipe shapes.

It has also proved very advantageous if the arms have a bend or a bend point.

The arm can thereby also be adapted to different pipe diameters.

A further very advantageous embodiment of the invention is also present if the arms are formed to be curved.

An improved centring and mounting of the device in the pipe can thereby ensured.

It has also proved very advantageous if the arms are constructed to be resilient and/or foldable.

The arm can thus deflect in the case of excessive loading, whereby damage of the liner is prevented. If the arm is capable of folding away, this can be folded in for transport of the device.

According to the invention it has also proved very advantageous if the device has an at least approximately cylindrical body and the mounts are arranged to be distributed at least approximately uniformly over the circumference.

Wheels can thus be mounted in almost any desired orientation.

A further advantageous development of the invention is also present when a detent device capable of securing the arms is provided at each mount.

The arms can thereby be simply and quickly inserted and also removed again.

In that case it has also proved very advantageous if the mounts are of two-part construction and comprise a fastening part and a guide part.

The arms are thus stably and securely mounted. Forces which arise are accepted.

According to the invention it is also very advantageous if the detent device is constructed as a detent pin or the like.

The arms can be securely and quickly detented by a detent pin.

A further very advantageous embodiment of the invention is also present if the arms have a circular, oval, polygonal, rectangular or the like cross-section.

A rotational securing and/or securing relative to inverted insertion can be realised by an embodiment of that kind.

According to a development of the invention it has also proved extremely advantageous if several light sources are constructed to be couplable together.

The device can thus be adapted to different liners and pipes and to the different ultraviolet light requirement.

In that case it has proved very advantageous if connecting members which are, at least in part, of flexible construction are provided for coupling the light sources.

Light sources coupled to one another can thereby also be pushed or pulled through curved pipes.

A further very advantageous embodiment of the invention is also present if the light sources also comprise lighting devices in the optical region, cameras, position sensors, temperature sensors and/or the like.

The ultraviolet hardening process can be monitored and checked by these additional devices.

In that case it has also proved very advantageous if modules are provided which have similar construction to the ultraviolet light sources and comprise lighting devices in the optical region, cameras, position sensors, temperature sensors and/or the like.

A chain of devices can thus be even more universally assembled, but nevertheless rapidly coupled together.

A further very advantageous embodiment is also present if the ultraviolet light sources are switchable and/or regulable.

Similarly, it is very advantageous if the ultraviolet light sources are switchable and/or regulable separately.

The radiation power can thereby be adapted in simple mode and manner to the specifics of the liner and the pipe.

The invention is clarified in the following by way of an exemplifying embodiment.

In that case:

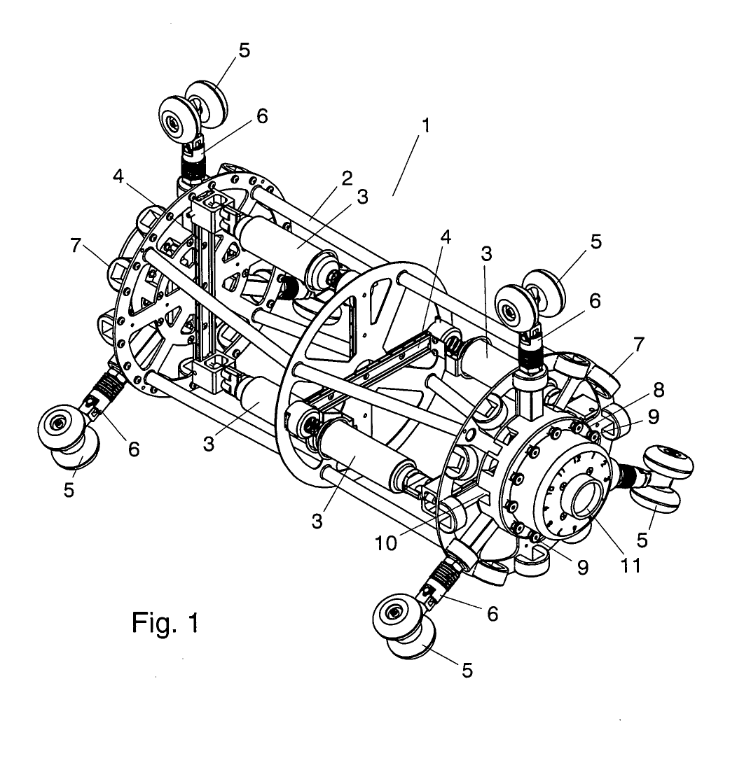

FIG. 1 shows a diagram of a device according to the invention with a wheel set for a round pipe of DN600,

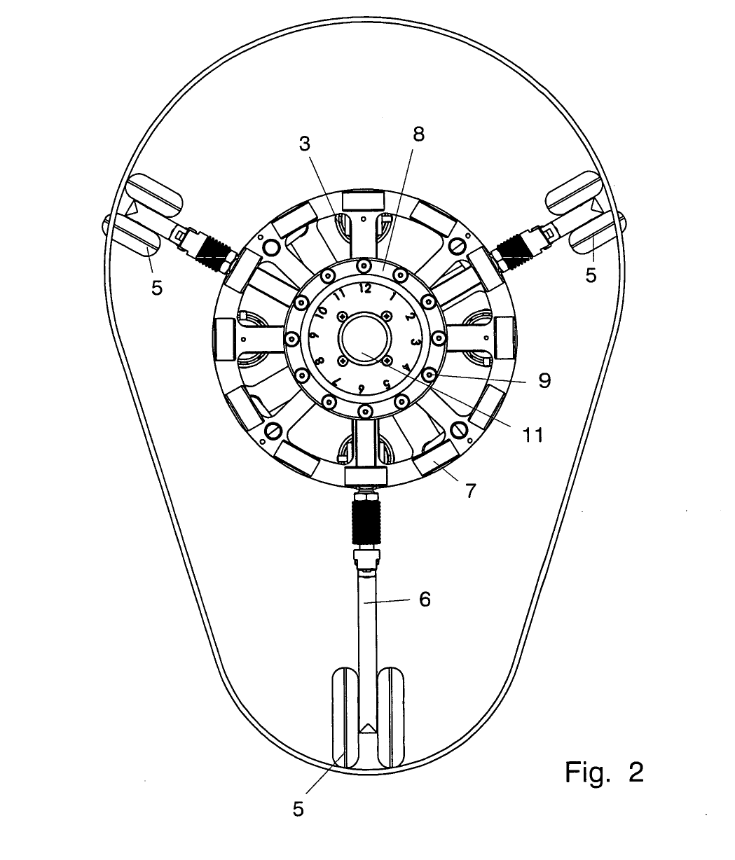

FIG. 2 shows a front view of the device with a wheel set for a pipe with an egg profile 750/500 and

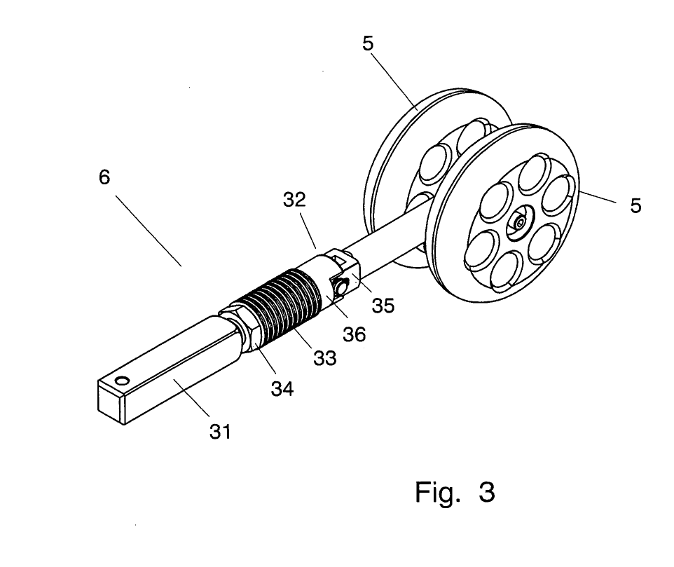

FIG. 3 shows a diagram of a wheel with arm.

A device for hardening plastic material liners for repair and refurbishment of pipe ducts is denoted in FIG. 1 by 1.

This device 1 is constructed from a comparatively open-work body 2 in which several ultraviolet lamps 3 are arranged. The body 2 has a substantially cylindrical outline. The ultraviolet lights can be changed in their position in the body 2 by way of an adjusting device 4, but also removed or exchanged in simple manner.

Provided at the ends of the body 2 are wheels 5, which are connected with the body 2 by way of an arm 6. The arm 6 is in that case plugged through a mount 7 and detented in a detent device 8 and thus secured against unintended slipping out. The detent device 8 in that case comprises a plurality of detent pins 9 which are distributed uniformly over the circumference. In the illustrated exemplifying embodiment twelve detent pins 9 are provided. An insertion opening 10 into which the arm 6 can be plugged is associated with each detent pin 9.

A respective mount 7 is associated with each pairing of insertion opening 10 and detent pin 9.

Other numbers and distributions in the arrangement of the detent pins 9, insertion openings 10 and mounts 7 are conceivable.

Usually three wheels 5 are provided per end. Depending on the respective pipe diameter the arms 6 of the wheels can have different lengths. For example, in the case of a pipe with an egg profile, as is illustrated in FIG. 2, one arm 6 of the three wheels 5 can be constructed to be longer and thus ensure an optimum centring of the device in the liner to be hardened. In addition, an eccentric centring by arms 6 of different length is conceivable with round pipe cross-sections.

For this purpose, the arms 6 can also be constructed to be adjustable in length.

The arms 6 can be plugged as desired into the mounts 7, so that the position of the device in the pipe can also thereby be predetermined. Turning relative to one another of several devices 1 coupled in series is thereby conceivable. An improved illumination of the liner to be hardened is given by such turning. Compensation for shading by the body 2 of the device 1 is thus provided by way of several devices 1.

Provided for coupling several devices 1 in succession is a coupling 11 which enables not only a mechanical coupling, but also an electrical connection. A connecting cable at such a coupling 11 can also be connected with a control device (not illustrated) and/or a traction or thrust cable.

Movable connecting members which either comprise joints or, however, are of flexible construction overall can be provided for coupling several devices 1.

Optical lighting devices, cameras, temperature sensors, position sensors or the like can also be used in the mounts 7 in order to control and monitor the hardening process. It is also conceivable that these are mounted in separate mounts at the ends of the body 2 or, however, are mounted in the body 2 additionally to or in exchange for ultraviolet lamps 3.

In the illustrated exemplifying embodiment the arms 6 are furnished with a square section 31 which is plugged into the mounts 7 and into the detent device 8. An effective securing against rotation is given by this square section 31.

Provided between the section 31 and the wheel 5 is a bending point 32 loaded by a settable spring 33. The bias of the spring 33 is settable by a setting nut 34.

The bend point 32 is in that case of two-part construction and consists of a bend joint 35 which is supported by a sleeve 36.

The spring 33 acts on the sleeve 36.

A spontaneous pivoting away of the wheels 5 at the bend point 32 is avoided by the sleeve 36. A force from which the wheels pivot away via the bend point 32 is predetermined in dependence on the bias of the spring 33. If a wheel is now blocked by an obstacle in the plastics material liner or in the pipe to be lined and a risk of damage to the plastics material liner thereby exists, the wheel 5 pivots away from the direction of movement of the device 1 in the pipe and reorientates itself as soon as the obstacle is overcome. The force from which the wheel 5 is pivoted away is determined by the spring bias.

In order to ensure realignment of the wheel the bend joint 35 is of spherical construction and the sleeve 36 has a corresponding design. Other designs are conceivable.

The ultraviolet light sources 3 can be regulated in common or separately from one another, whereby the hardening process can be controlled in correspondence with the monitoring.

Ultraviolet light sources 3 can also be removed or added depending on the respective pipe diameter and pipe shape to be processed. Moreover, it conceivable that, for example, by way of adapters at least a part of the ultraviolet light sources 3 is mounted outside the device 1 so that, for example, a uniform illumination arises in the case of a pipe with an egg profile.

1. Device for hardening plastics materials liners for pipe and conduit refurbishment, with at least one ultraviolet light source, wherein rollers for mounting the device in the pipe are provided and wherein a pushing and/or pulling device is provided by which the device can be pushed or pulled through the conduit pipe to be refurbished, wherein a plurality of mounts capable of mounting different rollers is provided.

2. Device according to claim 1, wherein the rollers are arranged at arms insertable into the mounts.

3. Device according to claim 1, wherein the arms are constructed to be adjustable in their length.

4. Device according to claim 1, wherein the arms have a bend or a bend point.

5. Device according to claim 1, wherein the arms are formed to be curved.

6. Device according to claim 1, wherein the arms are constructed to be resilient and/or foldable.

7. Device according to claim 1, wherein the device comprises at least one approximately cylindrical body and the mounts are arranged to be distributed at least approximately uniformly over the circumference.

8. Device according to claim 1, wherein a detent device capable of securing the arms is provided at each mount.

9. Device according to claim 1, wherein the mounts are of two-part construction and comprise a fastening part and a guide part.

10. Device according to claim 1, wherein the detent device is constructed as a detent pin or the like.

11. Device according to claim 1, wherein the arms have a circular, oval, polygonal, rectangular or the like cross-section.

12. Device according to claim 1, wherein several light sources are constructed to be couplable with one another, wherein connecting members which can be of flexible construction at least in part are provided for coupling the light sources.

13. Device according to claim 1, wherein the light sources also comprise lighting devices in the optical region, cameras, position sensors, temperature sensors and/or the like.

14. Device according to claim 1, wherein modules are provided which are constructed similarly to the ultraviolet light sources and comprise lighting devices in the optical region, cameras, position sensors, temperature sensors and/or the like.

15. Device according to claim 1, wherein the ultraviolet light sources are switchable and/or regulable, wherein the ultraviolet light sources can be switched and/or regulated separately.
